(19) United States
(12) Patent Application Publication
(10) Pub. No.: US 2021/0244053 A1
(43) Pub. Date: Aug. 12, 2021

(54) SYSTEM AND PROCESS FOR SOUS VIDE COOKING AND ENZYME TENDERIZATION

(71) Applicant: Sugar Creek Packing Co., Washington Court House, OH (US)

(72) Inventors: Mark Edward AUERNHEIMER, Henrico, VA (US); Craig O'BRIEN, Woodridge, IL (US)

(21) Appl. No.: 16/783,709

(22) Filed: Feb. 6, 2020

(51) Int. Cl. A23L 13/40; A47J 27/10; A47J 36/32; A23L 5/10; B65B 31/04; B65B 25/00

(52) U.S. Cl. CPC A23L 13/48; A47J 27/10; A47J 36/32; A23V 2002/00; B65B 31/048; B65B 25/001; A23L 5/13

(57) ABSTRACT

A system and process for sous vide cooking and enzyme tenderization of food. In an exemplary embodiment, a tenderizer applicator applies a selected enzyme tenderizer to uncooked protein pieces at a temperature below an activation temperature of the tenderizer; a packaging machine vacuum seals the uncooked protein pieces with inactive tenderizer in pouches; a sous vide cooker cooks the pouches a first temperature to activate the enzyme tenderizer for a first time interval to provide a selected tenderization of the protein pieces, then cooks the pouches of tenderized protein pieces at second temperature higher than the first temperature to deactivate the selected tenderizer for a second time interval to cease tenderization of the protein pieces and completely cook the tenderized protein pieces; and a chiller chills the cooked tenderized protein pieces in the pouches to cease cooking the protein pieces.

### TECHNICAL FIELD

This disclosure relates to systems and processes for cooking food, and more particularly, systems and processes for cooking protein using enzyme tenderizers.

### BACKGROUND

There is a need for systems and processes to cook animal protein so that it possesses pleasing organoleptic properties. Inexpensive cuts of animal protein, such as ungraded beef and poultry from spent hens, are often discarded because it is difficult or uneconomical to prepare it for human consumption. Such cuts can be tenderized by cooking the cuts for extended periods of time, but such slow production times are unsuitable for commercial operations because such cuts require prolonged cooking times and concomitant high energy input, high machine utilization cost, and overhead usage. Some types of animal protein simply are so tough that they are not usable.

Mechanical tenderization, in which the meat or animal protein is punctured with needles or thin blades, has been used to render tough cuts of meat palatable. However, mechanical tenderization has a limited effect on very tough cuts of meat and is ineffective on such cuts as bony ribs. Enzyme tenderizers such as papain and bromelain enzymes have been employed to tenderize proteins such as beef to chemically tenderize and speed up the tenderization process. However, a disadvantage with such tenderizers is that it is difficult to control the degree of tenderization of protein such tenderizers provide. Under tenderization of animal protein is ineffective and the protein remains tough and chewy. Over tenderization of animal protein renders the protein soft and pasty and not palatable.

Accordingly, there is a need for a system and process for precise control of tenderization of animal protein, in particular inexpensive and tough cuts of meat. In addition, there is a need for a system and process for tenderizing animal protein that is scalable to provide commercial volumes and throughput at a commercially acceptable cost.

### SUMMARY

The present disclosure describes embodiments of a system and process for sous vide cooking food, such as animal protein, to precisely control activation and deactivation of tenderization enzymes to provide a predetermined amount of tenderization of the animal protein from the enzyme. By selecting cooking time, temperature, and degree of tenderization, cooked animal proteins with pleasing organoleptic properties can be produced using inexpensive cuts of meat, and the cooking time can be accelerated without negatively impacting the product.

In embodiments, the system and process provide a desired degree of tenderization of cooked animal protein by sous vide cooking a mixture of uncooked animal protein and enzyme tenderizers at temperatures selected to activate and deactivate the added enzyme tenderizers. In embodiments, activation and deactivation of the tenderization enzymes is effected by controlling the sous vide cooking water bath temperature and residence time of the packaged animal protein. By controlling the activation and deactivation of tenderization enzymes during a sous vide process with precision, tough and comparatively inexpensive cuts of animal protein can be cooked without under or over tenderization of the animal protein.

In an exemplary embodiment, a system for sous vide cooking and enzyme tenderization includes a tenderizer applicator that receives uncooked protein pieces and applies a selected enzyme tenderizer to the uncooked protein pieces at a temperature below an activation temperature of the selected enzyme tenderizer, resulting in uncooked protein pieces with inactive tenderizer. A packaging machine vacuum seals the uncooked protein pieces with inactive tenderizer in pouches, resulting in vacuum sealed pouches of uncooked protein pieces with inactive tenderizer. A sous vide cooker is programmed to sous vide cook the vacuum sealed pouches of uncooked protein pieces with inactive tenderizer at a first temperature for a first time interval selected to raise the temperature of the selected enzyme tenderizer to activate the selected enzyme tenderizer to provide a selected degree of tenderization of the protein pieces, resulting in vacuum sealed pouches of tenderized protein pieces, then continue sous vide cooking the vacuum sealed pouches of tenderized protein pieces at second temperature, higher than the first temperature, for a second time interval selected to deactivate the selected enzyme tenderizer to cease tenderization of the protein pieces, resulting in cooked tenderized protein pieces in the vacuum sealed pouches. A chiller chills the cooked tenderized protein pieces in the vacuum sealed pouches sufficiently to cease cooking the cooked tenderized protein pieces.

In another exemplary embodiment, a process for sous vide cooking and enzyme tenderization of pieces of protein includes applying a selected enzyme tenderizer to uncooked protein pieces at a temperature below the activation temperature of the selected enzyme tenderizer, resulting in uncooked protein pieces with inactive tenderizer. The uncooked protein pieces with inactive tenderizer are vacuum sealed in pouches, resulting in vacuum sealed pouches of uncooked protein pieces with inactive tenderizer. The vacuum sealed pouches of uncooked protein pieces with inactive tenderizer are sous vide cooked at a first temperature selected to activate the selected enzyme tenderizer for a first time interval that raises the temperature of the entire protein pieces to the first temperature to provide a selected degree of tenderization of the protein pieces, resulting in vacuum sealed pouches of tenderized protein pieces. Then, the vacuum sealed pouches of tenderized protein pieces are further cooked at second temperature, higher than the first temperature, selected to deactivate the selected enzyme tenderizer for a second time interval to cease tenderization of the protein pieces and completely cook the tenderized protein pieces, resulting in completely cooked tenderized protein pieces in the vacuum sealed pouches.

In yet another exemplary embodiment of the process for sous vide cooking and enzyme tenderization, an enzyme tenderizer is first matched to protein pieces to be tenderized and cooked. The enzyme tenderizer is selected to have a peak enzyme activation temperature and an enzyme deactivation temperature within a cooking temperature of the protein pieces. A tenderizer applicator applies the enzyme tenderizer in an inactive state to the protein pieces in an uncooked state at a temperature below the activation temperature of the enzyme tenderizer, resulting in uncooked protein pieces with inactive tenderizer. The uncooked protein pieces with inactive tenderizer are vacuum sealed in pouches by a packaging machine, resulting in vacuum sealed pouches of uncooked protein pieces with inactive tenderizer. The vacuum sealed pouches of uncooked protein pieces with inactive tenderizer by a sous vide cooker at the peak enzyme activation temperature for a first time interval to provide a selected degree of tenderization of the protein pieces, resulting in vacuum sealed pouches of tenderized protein pieces, then increasing the temperature in the sous vide cooker to continue to sous vide cook the vacuum sealed pouches of tenderized protein pieces at the enzyme deactivation temperature to deactivate the selected enzyme tenderizer for a second time interval to cease tenderization of the protein pieces, resulting in completely cooked tenderized protein pieces in the vacuum sealed pouches.

Other objects and advantages of the disclosed system and process for sous vide cooking and enzyme tenderization will be apparent from the following description, the accompanying drawings, and the appended claims.

### BRIEF DESCRIPTION OF THE DRAWINGS

FIG. 1 is a schematic representation of an embodiment of the disclosed system for sous vide cooking and enzyme tenderization;

FIG. 2 is a perspective view of an exemplary sheet of vacuum sealed pouches containing animal protein with enzyme tenderizer according to the disclosed system for sous vide cooking and enzyme tenderization;

FIG. 3 is a graph showing relative enzyme activity plotted against temperature for an exemplary protease enzyme used in the disclosed system and process;

FIG. 4 is a graph showing sous vide bath cooking temperature plotted against time for an embodiment of the disclosed system and process; and

FIG. 5 is another graph showing sous vide bath cooking temperature plotted against time for another embodiment of the disclosed system and process.

### DETAILED DESCRIPTION

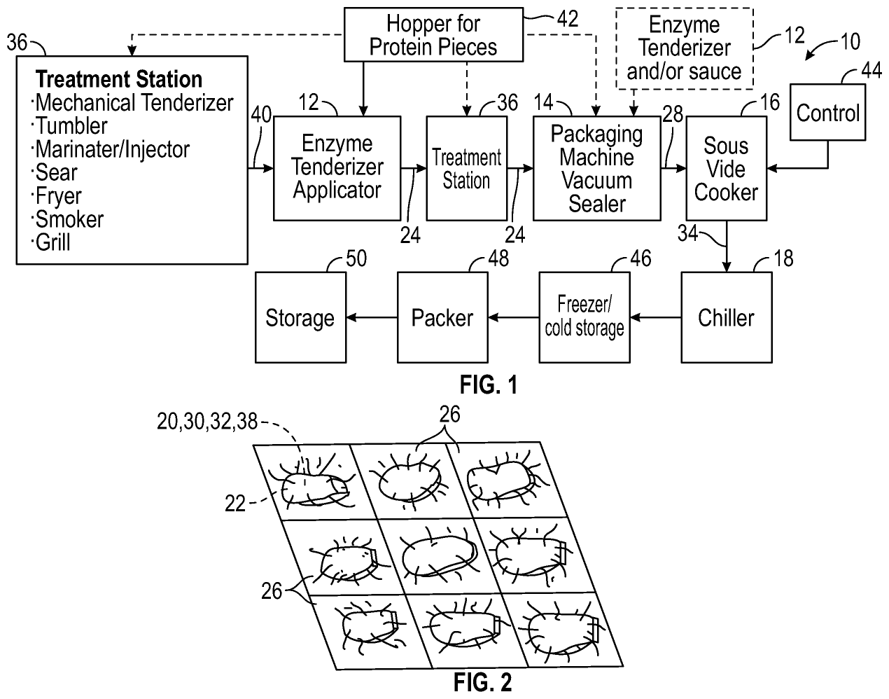

As shown in FIG. 1, in an exemplary embodiment, a system for sous vide cooking and enzyme tenderization, generally designated 10, includes a tenderizer applicator 12, a packaging machine 14, a sous vide cooker 16, and a chiller 18. The tenderizer applicator 12 receives raw and/or uncooked protein pieces 20 (see FIG. 2) and applies a selected quantity of a selected enzyme tenderizer 22 to the uncooked protein pieces at a temperature below the activation temperature, in embodiments the peak activation temperature, of the selected enzyme tenderizer, resulting in uncooked protein pieces with inactive tenderizer. In an embodiment, the enzyme tenderizer 22 is applied to the outer surfaces of the uncooked protein pieces 20 at an enzyme temperature, and in embodiments the temperature of the uncooked protein piece 20, below the activation temperature of the enzyme tenderizer 22, and in embodiments the peak enzyme activation temperature. Optionally, other ingredients are added with the enzyme tenderizer, such as sauces, spices, flavorings, spoilage inhibitors, and combinations of the foregoing.

The packaging machine 14 receives the uncooked protein pieces 20, coated with enzyme tenderizer 22 in an inactive state (i.e., coated with inactive enzyme tenderizer), from the tenderizer applicator 12. In embodiments, the uncooked protein pieces 20 are conveyed by a conveyor 24 from the tenderizer applicator 12 to the packaging machine 14; in other embodiments, the uncooked protein pieces are conveyed manually. The packaging machine 14 vacuum seals the uncooked protein pieces 20 with inactive enzyme tenderizer 22 in pouches 26, resulting in vacuum sealed pouches of uncooked protein pieces with inactive tenderizer.

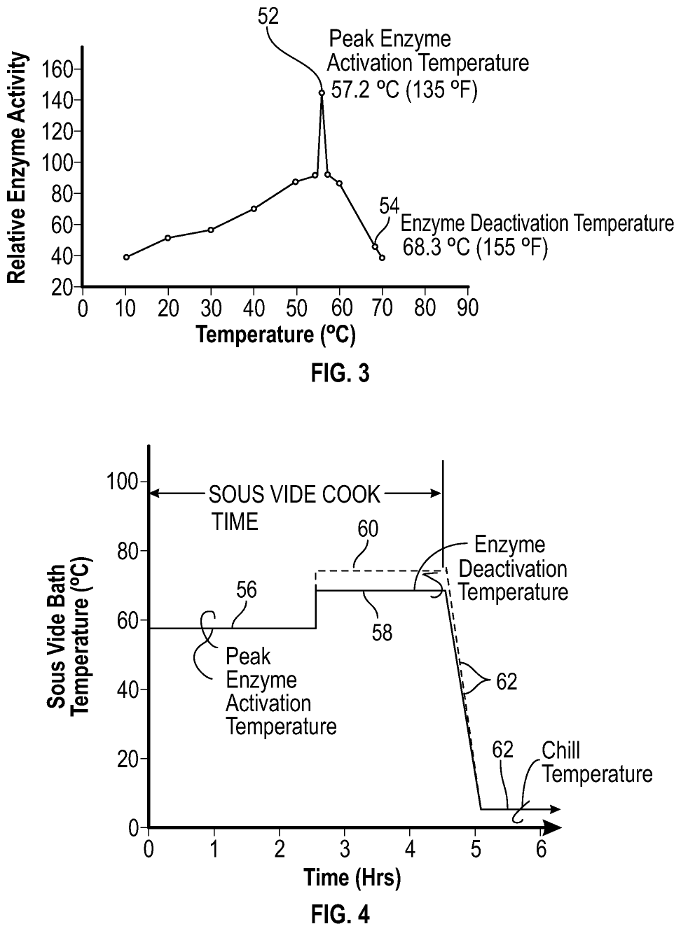

The vacuum sealed pouches 26 of uncooked protein pieces 20 with inactive enzyme tenderizer 22 are conveyed from the packaging machine 14 to the sous vide cooker 16, in some embodiments by a conveyor 28, and in other embodiments manually. The sous vide cooker 16 is programmed to sous vide cook the vacuum sealed pouches 26 of uncooked protein pieces 20 with inactive enzyme tenderizer 22 at a first temperature selected to activate the selected enzyme tenderizer for a first time interval that raises the temperature of the entire protein pieces 20 to the first temperature to provide a selected degree of tenderization of the protein pieces, resulting in vacuum sealed pouches 26 of tenderized protein pieces 30. In embodiments, the first temperature is the peak enzyme activation temperature (see FIG. 3).

The sous vide cooker 16 then sous vide cooks the vacuum sealed pouches 26 of tenderized protein pieces 30 at a second temperature, higher than the first temperature, that is selected to deactivate the selected enzyme tenderizer 22 for a second time interval. This higher temperature sous vide cooking raises the temperature of the protein pieces 20 and the enzyme tenderizer 22 to deactivate the tenderizer throughout the protein pieces, which ceases tenderization of the protein pieces and continues to cook the tenderized protein pieces to completion, resulting in cooked tenderized protein pieces 32 in the vacuum sealed pouches 26. In an embodiment, the cooked tenderized protein pieces 32 in the vacuum sealed pouches 26 are conveyed from the sous vide cooker 16 to the chiller 18 by a conveyor 34, and/or manually. The chiller 18 chills the completely cooked tenderized protein pieces 32 in the vacuum sealed pouches 26 sufficiently to cease cooking the cooked tenderized protein pieces.

In embodiments of the system 10, the tenderizer applicator 12 is selected from a vacuum tumbler and an enzyme injector. In embodiments, the packaging machine 14 takes the form of a thermoforming packaging machine, such as the model R 515 high-performance thermoforming packaging machine manufactured by MULTIVAC Sepp Haggenmüer SE & Co. KG, of Wolfertschwenden Germany. In other embodiments, the packaging machine 14 takes the form of a manual vacuum chamber machine (e.g., MULTIVAC model B210), a rotary bag filler (e.g., CRYOVAC model 8600 E-series manufactured by Sealed Air Corp. of Charlotte, N.C.), a rotary bag sealer (e.g., CRYOVAC model 8300 by Sealed Air Corp.), a vacuum tray sealer (e.g., TRAVE 590 XL by G. MONDINI spa of Cologne, Italy), a skin packaging machine (e.g., MSTS series by Starview Packaging Machinery, Inc. of Dorval, Quebec, Canada), a semiautomatic vertical sealer, and a stuffer with a tipper tie or polyclip machine.

In embodiments, the system 10 further includes treatment station 36. In embodiments, the treatment station 36 takes the form of a tenderizer that receives the uncooked protein pieces 20 and mechanically tenderizes the uncooked protein pieces, resulting in uncooked mechanically tenderized protein pieces 38. In an embodiment, the tenderizer applicator 12 receives the uncooked mechanically tenderized protein pieces 38 from the mechanical tenderizer of treatment station 36 by a conveyor 40, and/or manually. In embodiments, the mechanical tenderizer of the treatment station 36 is selected from a needle tenderizer and a knit-knife blade tenderizer.

In embodiments, the treatment station 36 takes the form of a tumbler for tumbling the uncooked protein pieces 20 in spices and/or flavorings, a marinator for marinating the uncooked protein pieces, a sear station for searing the uncooked protein pieces, a fryer for partially or fully frying the uncooked protein pieces, a smoker for smoking the uncooked protein pieces, a grill for grilling the uncooked protein pieces, and combinations of the foregoing.

In an embodiment, the treatment station 36 is located upstream of the tenderizer applicator 12, so that the tenderizer applicator receives the uncooked protein pieces 20 from the treatment station. In another embodiment, the system 10 includes instead or in addition a treatment station 36 located downstream of the tenderizer applicator 12, so that the treatment station receives the uncooked protein pieces 20 coated with inactivated enzyme tenderizer 22 from the tenderizer applicator.

In an exemplary embodiment of the system 10, the uncooked protein pieces 20 take the form of animal protein pieces. In embodiments, the animal protein pieces 20 are selected from beef, pork, lamb, veal, poultry such as chicken, and combinations thereof. The enzyme tenderizer 22 selected is determined by the characteristics (i.e., size, shape, toughness, and normal sous vide cook time and temperature) of the protein to be tenderized. The enzyme tenderizer 22 is selected to match enzyme activation temperature and deactivation temperature to product (e.g., animal protein) cook requirements. In embodiments, the enzyme tenderizer 22 is selected from liquid or dry ficin, protease from aspergillus niger, protease from aspergillus orzae, actinidin, protease from bacillus subtilis, bromelain, and combinations of the foregoing. In an embodiment, the selected enzyme tenderizer 22 is a protease powder diluted in water to a range of between 0.0157 protease units to 0.0787 protease units per gram of protein pieces 20.

In an embodiment of the process for sous vide cooking and enzyme tenderization, the process begins by applying an inactive enzyme tenderizer 22, which is selected as discussed previously, to uncooked protein pieces 20 at a temperature below the activation temperature of the selected enzyme tenderizer, and in embodiments below the peak enzyme activation temperature, resulting in uncooked protein pieces with inactive tenderizer. The uncooked protein pieces 20, now coated with inactive tenderizer, are placed in pouches 26 and the uncooked protein pieces are vacuum sealed by the packaging machine 14, resulting in vacuum sealed pouches of uncooked protein pieces with inactive tenderizer. The vacuum sealed pouches 26 of uncooked protein pieces 20, which in embodiments are coated with inactive enzyme tenderizer 22, are then transported to the sous vide cooker 16.

There, the pouches 26 of uncooked protein pieces 20 with inactive enzyme tenderizer 22 are sous vide cooked at a first temperature selected to activate the selected enzyme tenderizer 22, and in embodiments at a temperature selected to raise the temperature of the tenderizer to the peak enzyme activation temperature, and held at the first temperature for a first time interval that raises the temperature of the entire protein pieces to the first temperature to provide a selected degree of tenderization of the protein pieces, resulting in vacuum sealed pouches of tenderized protein pieces 30. In an embodiment, the first temperature is a temperature that is the optimal or peak tenderizing temperature for the selected enzyme tenderizer 22. The hold time will vary depending on the protein being cooked, the cut, the meat age, Ph of the protein pieces 20 and/or enzyme tenderizer 22, use level of enzyme tenderizer, and the presence of other ingredients, such as phosphates, herbs, spices, and fruit additions.

The cooking process continues in the sous vide cooker 16 until the desired culinary product results for the tenderized protein pieces 30 are reached. At that time, the sous vide cook temperature is increased to a second temperature, higher than the first temperature, selected to deactivate the selected enzyme tenderizer 22 by denaturing and rendering non-functional the enzyme tenderizer (e.g., above the peak enzyme activation temperature) for a second time interval that ceases tenderization of the tenderized protein pieces 30. The pouches 26 of cooked tenderized protein pieces 32 are held at this sous vide cook temperature and completely cooked, resulting in completely cooked tenderized protein pieces 32 in the vacuum sealed pouches 26.

After cooking in the sous vide cooker 16, the completely cooked tenderized protein pieces 32 are transported by conveyor 34 to the chiller 18 and chilled. In other embodiments of the system 10, the chiller 18 is incorporated into (i.e., is a component of) the sous vide cooker 16 and the external conveyor 34 is not required. In embodiments, the completely cooked tenderized protein pieces 32 in the vacuum sealed pouches 26 are chilled sufficiently to cease cooking the completely cooked tenderized protein pieces.

In an embodiment, the process further includes initially selecting an enzyme tenderizer 22 having a peak enzyme activation temperature within the cooking range of the protein pieces 20. In an embodiment, selecting the enzyme tenderizer 22 includes selecting an enzyme tenderizer also having an enzyme deactivation temperature within the cooking range of the protein pieces 20. By selecting an enzyme tenderizer 22 having a peak enzyme activation temperature within the cooking range of the protein pieces 20, not only is cook and tenderization time reduced, but the amount of enzyme tenderizer 22 required to achieve a desired degree of tenderization is minimized, so that the tenderizer is less likely to adversely affect the taste of the cooked tenderized protein pieces 32.

In another embodiment, a process for sous vide cooking and enzyme tenderization begins by matching an enzyme tenderizer 22 to uncooked protein pieces 20 to be tenderized and cooked. The enzyme tenderizer 22 is selected to have a peak enzyme activation temperature and an enzyme deactivation temperature within the cooking temperature range of the protein pieces 20. A tenderizer applicator 12 applies the selected enzyme tenderizer 22 to the protein pieces 20 in an uncooked state at a temperature below the activation temperature, and in embodiments the peak enzyme activation temperature, of the selected enzyme tenderizer, resulting in uncooked protein pieces with inactive tenderizer.

In embodiments, the inactive enzyme tenderizer 22 is applied to the uncooked protein pieces 20 by an enzyme tenderizer applicator 12, which in embodiments applies a coating of tenderizer to the protein pieces, marinates the protein pieces with tenderizer, and/or injects the protein pieces with tenderizer. The uncooked protein pieces 20, coated and/or injected with tenderizer, optionally are conveyed to a treatment station 36, where they are mechanically tenderized, tumbled, injected with marinade, seared, fried, smoked, grilled, or combinations of the foregoing. In embodiments, the treatment station 36 treats the uncooked protein pieces upstream of the tenderizer applicator 12. The uncooked protein pieces 20, coated and/or injected with enzyme tenderizer 22, are conveyed to a packaging machine 14, which in embodiments is a thermoforming packaging machine.

In other embodiments, the enzyme tenderizer applicator 12 deposits enzyme tenderizer 22 directly into the pouches 26 in the packaging machine 14, either before, substantially simultaneously with, or subsequent to placement of the uncooked protein pieces 20 into the pouches of the packaging machine. Optionally with either embodiment, sauce, which in embodiments consists of or includes spices, is added to the pouches 26 along with, prior to, or subsequent to the enzyme tenderizer 22. In other options, the enzyme tenderizer 22 is mixed with the sauce before it is added to the pouches 26. The packaging machine 14 vacuum seals the uncooked protein pieces 20 with inactive tenderizer in the pouches 26, resulting in vacuum sealed pouches of uncooked protein pieces with inactive enzyme tenderizer 22. In embodiments, the system 10 includes a hopper 42 that receives the uncooked protein pieces 20 and deposits them into the enzyme tenderizer applicator 12. As shown in FIG. 1, in embodiments the tenderizer applicator 12 applies the enzyme tenderizer 22 in an inactive state to the protein pieces 20 in an uncooked state selected from applying the enzyme tenderizer directly to the protein pieces, injecting the protein pieces with the enzyme tenderizer, depositing the enzyme tenderizer in the pouches 26 in the packaging machine 14 prior to, simultaneously with, or subsequent to placing the protein pieces in the pouches, and combinations of the foregoing.

In other embodiments, the hopper 42 deposits the uncooked protein pieces 20 into the treatment station 36 or directly into pouches 26 in the packaging machine 14.

The vacuum sealed pouches 26 of uncooked protein pieces 20 and inactive enzyme tenderizer 22 are conveyed from the packaging machine 14 by conveyor 28 to sous vide cooker 16 and sous vide cooked. In embodiments, the sous vide cooker 16 is programmed to cook at the peak enzyme activation temperature for a first time interval to provide a selected degree of tenderization of the protein pieces, resulting in vacuum sealed pouches 26 of tenderized protein pieces 30. The temperature is then increased in the sous vide cooker 16 to sous vide cook the vacuum sealed pouches 26 of tenderized protein pieces 30 at the enzyme deactivation temperature to deactivate the selected enzyme tenderizer 22 for a second time interval to cease tenderization of the partially cooked tenderized protein pieces 30 and completely cook the tenderized protein pieces, resulting in completely cooked tenderized protein pieces 32 in the vacuum sealed pouches 26.

In an embodiment, the system 10 includes a control 44 that is either integral with the sous vide cooker 16 or is a remote unit that controls the sous vide cooker, either wirelessly, by wire, or over a network, and may be onsite or remote from the remainder of the system 10. Optionally, the control 44 coordinates operation of the sous vide cooker 16 with one or more of the other components of the system, including the hopper 42, treatment station 36, enzyme tenderizer applicator 12, packaging machine 14, and chiller 18 (which in embodiments is integral with or a component of the sous vide cooker), as well as the interconnecting conveyors 24, 28, 34, 40.

Exemplary temperature and time graphs for operation of embodiments of the system 10 described herein are shown in FIGS. 3 and 4. FIG. 3 shows relative enzyme activity plotted against temperature for an enzyme tenderizer 22, which in this embodiment is a protease enzyme tenderizer such as Bioprotease 900NP manufactured by Kerry Food Ingredients (Cork) Ltd., Carrigaline, Ireland. As shown in FIG. 3, the protease enzyme tenderizer 22 reaches its peak activation effectiveness of 160 on a relative scale at 52, which is 57.2° C. (135° F.) on the graph, and deactivates at 54, which is about 68.3° C. (155° F.) on the graph. This peak tenderization temperature appears as a spike at 52 on the activity curve shown in FIG. 3. Accordingly, it is desirable to maintain the temperature of the protein pieces 20 and enzyme tenderizer 22 within the narrow temperature range of the spike representing the peak enzyme activation temperature, which in this example is 57.2° C.±1° C. (135° F.±1.8° F.). In embodiments, the control 44 maintains the heated water bath of the sous vide cooker 16 at a temperature that maintains the cooking temperature of the pouches 26, protein pieces 20 and enzyme tenderizer 22 during the first cooking time interval within this peak enzyme activation temperature to achieve optimal tenderization efficiency. The sous vide cooker 16 also is capable of rapidly raising the water bath temperature to the deactivation temperature, shown at 54 on the activity curve as 68.3° C. (155° F.).

As shown in FIG. 4, using the tenderization enzyme of, or similar in activation and deactivation characteristics to that of FIG. 3, an exemplary sous vide cooking profile for a protein such as beef begins by heating the uncooked protein pieces 20 (FIG. 2) coated and/or injected with the inactive enzyme tenderizer 22 in the sous vide cooker 16 for a first time interval 56 to the peak enzyme activation temperature 52 (FIG. 3) of 57.2° C. (135° F.) and held at that temperature for approximately 2.5 hours. An advantage of the disclosed system 10 and process is that the liquid bath (typically water) of the sous vide cooker 16 can be maintained at the selected temperature so that the pouches 26 of uncooked protein pieces 20 are immediately contacted by and completely immersed in water at that temperature (or slightly above if necessary to maintain the enzyme tenderizer 22 at the peak enzyme activation temperature 52). The water bath of the sous vide cooker 16 rapidly transfers heat energy to through the pouch 26 material, which in embodiments is a thin food-grade plastic, to the protein pieces 20 faster than other forms of cooking, such as steam, microwave, infrared (IR) and other forms of radiant heating, and combinations of the foregoing.

This first time interval 56 at the peak enzyme activation temperature 52 partially cooks the protein pieces 20 and at the same time activates the enzyme tenderizer 22 to tenderize them to a desired or selected degree. The sous vide cooker 16 then is actuated to raise the cooking temperature of the water bath to at least 68.3°-70° C. (155°-158° F.), which is the enzyme deactivation temperature, and hold at that temperature for a second time interval 58, which in the embodiment is approximately 2 hours. As shown by the dashed line 60, in an embodiment, the sous vide cooking temperature and tenderized protein pieces 30 can be raised higher by the sous vide cooker 16 if desired to achieve faster cooking or a desired cooking effect. For example, the sous vide cooking temperature for protein pieces 20 comprising chicken is selected to be 75° C. (165° F.) to get to at least 71° C. (160° F.) as an internal temperature, indicated by dashed line 60 in FIG. 4.

Also shown in FIG. 4, the cooking process ends with chilling, in embodiments rapid chilling, the now tenderized and cooked protein pieces 32 in the vacuum sealed pouches 26 by the chiller 18, indicated by line 62. The chill temperature and time are selected to cease cooking the completely cooked tenderized protein pieces 32. In embodiments, the chiller 18 is actuated by the control 44 (FIG. 1), which coordinates the sous vide cooking and chilling process steps and chills to between 0° and 4.4° C. (32° and 40° F.), or alternately freezes to −15° C. (5° F.).

Accordingly, the process embodied in FIG. 4 sous vide cooks the uncooked protein pieces 20 at the peak enzyme activation temperature 52 (FIG. 3) to raise the temperature of the entire protein pieces 20 to the peak enzyme activation temperature and partially cooks the protein pieces. In embodiments, the enzyme tenderizer is protease of bacillus subtilis, the enzyme activation temperature is 135° F. (57.2° C.), the enzyme deactivation temperature is 155° F. (68.3° C.), and the protein pieces are beef

After chilling the tenderized and cooked protein pieces 32 in vacuum sealed pouches 26, in embodiments the pouches are stored in a freezer/cold storage 46 and kept either frozen or chilled. From the freezer/cold storage 46, the pouches 26 in embodiments are packed in boxes in a packing station 48 and shipped to storage 50, which in embodiments is at a location of a purchaser. Later, in embodiments the pouches 26 are separated and the cooked tenderized protein pieces 32 reheated for consumption, either by a retail restaurant or by a consumer. In embodiments, the tenderized and cooked protein pieces 32 are reheated, for example by microwaving, grilling, broiling, or baking, or by battering and flash frying. Alternatively, the cooked tenderized protein pieces 32 are kept in the pouches 26 and microwaved.

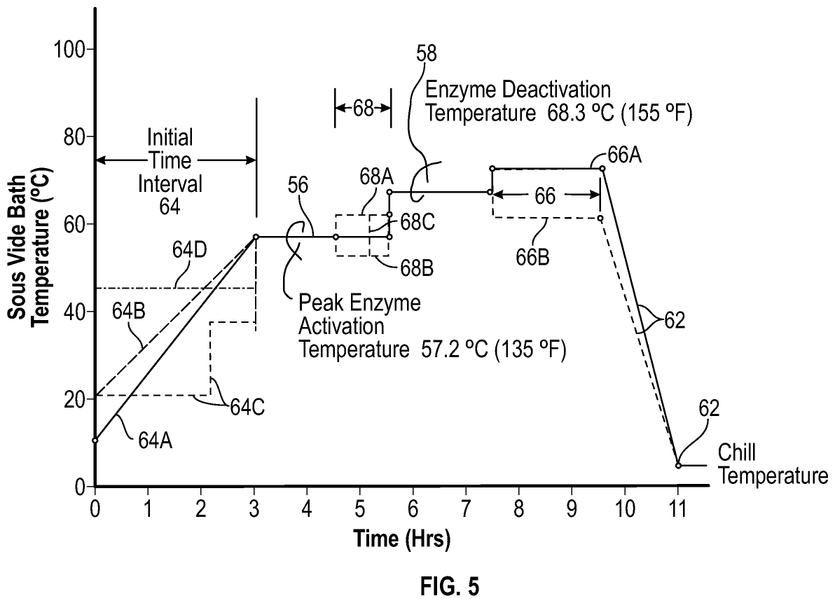

As shown in FIG. 5, in embodiments, the disclosed system 10 can perform enzyme tenderization processes using multiple time intervals of different sous vide cook temperatures. For example, the vacuum sealed pouches 26 of uncooked protein pieces 20 and inactive enzyme tendrizer 22, initially are placed into the sous vide cooker 16 in which the water bath is below the peak enzyme activation temperature 52 of the selected enzyme tenderizer 22, and the water bath and protein pieces 20 are heated during an initial cooking time interval 64, shown in FIG. 5 as 3 hours, to the peak enzyme activation temperature to begin the first time interval 56. During this initial cooking time interval 64 the enzyme tenderizer 22 is inactive. Such an initial cooking time interval 64 in which the enzyme tenderizer 22 is inactive may be desirable for cooking fowl and poultry.

In one embodiment, the initial cooking time interval 64 begins with a sous vide bath temperature of 10° C. (50° F.) and the bath is gradually heated as shown in line 64A to heat the protein pieces 20 and enzyme tenderizer 22 to the peak enzyme activation temperature 52 (FIG. 3). In other embodiments, the initial cooking time interval 64 starts at a higher bath temperature, for example 21° C. (70° F.) shown as line 64B, and the sous vide cooker 16 gradually raises the temperature of the bath, protein pieces 20 and enzyme tenderizer 22 to the peak enzyme activation temperature 52 to begin the first time interval 56. In other embodiments, during the initial cooking time interval 64, the sous vide cooker 16 heats the bath in stepped stages, indicated by stepped line 64C, from an initial temperature of 20° C. (68° F.) for a first stage of 2¼ hours, then for a second stage of ¾ hours at 38° C. (100° F.).

In still other embodiments, initial time intervals of greater or fewer stages and temperatures in which the sous vide cooker 16 cooks the protein pieces 20 and enzyme tenderizer 22 at temperatures below the peak enzyme activation temperature 52. Alternatively, the initial cooking time interval 64 is selected to cook the protein pieces 20 and enzyme tenderizer 22 at a substantially constant elevated temperature, indicated by line 64D, which is, for example at 45° C. (113° F.) for the entire initial cooking time interval 64. At the end of the initial cooking time interval 64, the protein pieces 20 and enzyme tenderizer 22 are heated to the peak enzyme activation temperature 52.

Alternatively, or in addition, subsequent to the second time interval 58, the sous vide cooker 16 raises the temperature of the bath, and thus the tenderized protein pieces 30 vacuum sealed in pouches 26, for a third time interval 66, shown as 2 hours in FIG. 5. Holding the tenderized protein pieces 30 with deactivated enzyme tenderizer 22 at a higher temperature, indicated by line 66A for an exemplary temperature of 75° C. (167° F.) is desirable for tougher cuts of meat, such as highly shredded pork. Alternatively, after deactivation of the enzyme tenderizer 22 resulting from heating the tenderized protein pieces 30 and tenderization enzyme to the enzyme deactivation temperature 54 (FIG. 3), the bath temperature in the sous vide cooker 16 is lowered to lower the temperature of the tenderized protein pieces 30 below the enzyme deactivation temperature 54. The temperature shown in FIG. 5 at 66B is 55° C. (131° F.), which is below the peak enzyme activation temperature 52, but in an embodiment can be between the enzyme activation temperature and the enzyme deactivation temperature 54. Such a third time interval 66 is desirable for cooking beef to avoid excess water loss.

In another embodiment shown in FIG. 5, the sous vide cooker 16 is programmed to hold the protein pieces 20 for a fourth time interval 68 at a temperature above the peak enzyme activation temperature 52 and below the enzyme deactivation temperature 54 indicated by line 68A, or below both the enzyme activation temperature and the enzyme deactivation temperature, as indicated by line 68B. This deviation from the peak enzyme activation temperature 52 during the first time interval 56 may continue until the sous vide bath raises the temperature of the protein pieces and enzyme tenderizer 22 to the enzyme deactivation temperature 54, or as indicated by line 68C, ceases prior to the end of the first time interval and the sous vide cooker 16 adjusts the bath temperature so that the protein pieces 20 and tenderization enzyme return to the peak enzyme activation temperature 52. This dwell time ceases or reduces significantly the tenderizing action of the enzyme tenderizer 22, which in embodiments is temporary, to provide lower temperature cooking of the protein pieces but without enzyme tenderization.

The foregoing system 10 and methods produce vacuum sealed pouches of fully cooked tenderized protein with pleasing organoleptic properties at a high volume or rate of production compared to known methods and systems. The precise temperature control inherent in sous vide cooking allows tenderization of the selected protein at the peak enzyme tenderization temperature of the selected enzyme tenderizer, and as discussed with reference to FIG. 5, great flexibility in developing protein cooking processes, so that the protein is neither under tenderized, wherein it would have a tough, chewy consistency, nor over tenderized, wherein it would have a soft, pasty consistency.

In addition, sous vide cooking programs can be developed to maintain moisture and hence taste and tenderness in the cooked protein. Accordingly, this process and system 10 are especially useful in preparing comparatively tougher, less-expensive cuts of protein, such as select or ungraded beef, spent hen deboned meat (white or dark), sow ribs, cow ribs, peasant cuts, utility grade ready to shred, utility steaks, clod meat, chuck meat, barbacoa ready-to-shred cook reduction, large bird turkey meat (e.g., legs, wings), turkey drumettes, shoulder items, brisket, eye round steak, stop round steak, and skirt steak.

Another advantage of the disclosed system and process is that it enhances and accelerates tenderization of the protein food product because the cooking is conducted at peak enzyme activation temperature. Tests have shown that cook times can be reduced from 5% to 70% as a result.

While the foregoing systems and methods constitute preferred embodiments of the system and process for sous vide cooking and enzyme tenderization, it is to be understood that the invention is not limited to these precise methods and systems, and that changes may be made therein without departing from the scope of the invention.

What is claimed is:

1. A system for sous vide cooking and enzyme tenderization, the system comprising:
a tenderizer applicator that applies a selected enzyme tenderizer to uncooked protein pieces at a temperature below an activation temperature of the selected enzyme tenderizer, resulting in uncooked protein pieces with inactive tenderizer;
a packaging machine that vacuum seals the uncooked protein pieces with inactive tenderizer from the tenderizer applicator in pouches, resulting in vacuum sealed pouches of uncooked protein pieces with inactive tenderizer;
a sous vide cooker that is programmed to sous vide cook the vacuum sealed pouches of uncooked protein pieces with inactive tenderizer at a first temperature for a first time interval selected to raise the temperature of the selected enzyme tenderizer to activate the selected enzyme tenderizer to provide a selected degree of tenderization of the protein pieces, resulting in vacuum sealed pouches of tenderized protein pieces, then continue sous vide cooking the vacuum sealed pouches of tenderized protein pieces at second temperature, higher than the first temperature, for a second time interval selected to deactivate the selected enzyme tenderizer to cease tenderization of the protein pieces, resulting in cooked tenderized protein pieces in the vacuum sealed pouches; and
a chiller that chills the cooked tenderized protein pieces in the vacuum sealed pouches sufficiently to cease cooking the cooked tenderized protein pieces.

2. The system of claim 1, wherein the tenderizer applicator is selected from a vacuum tumbler and an enzyme injector.

3. The system of claim 1, wherein the packaging machine is a thermoforming packaging machine.

4. The system on claim 1, further comprising a tenderizer that receives the uncooked protein pieces and mechanically tenderizes the uncooked protein pieces, resulting in uncooked mechanically tenderized protein pieces; and the tenderizer applicator receives the uncooked mechanically tenderized protein pieces from the mechanical tenderizer.

5. The system of claim 1, wherein the mechanical tenderizer is selected from a needle tenderizer and a knit-knife blade tenderizer.

6. The system of claim 1, further comprising a treatment station selected from a tumbler for tumbling the uncooked protein pieces in spices and/or flavorings, a marinator for marinating the uncooked protein pieces, a sear station for searing the uncooked protein pieces, a fryer for frying the uncooked protein pieces, a smoker for smoking the uncooked protein pieces, a grill for grilling the uncooked protein pieces, and combinations of the foregoing.

7. The system of claim 6, wherein the treatment station is located upstream of the tenderizer applicator; and the tenderizer receives the uncooked protein pieces from the treatment station.

8. The system of claim 6, wherein the treatment station is located downstream of the tenderizer applicator; and the treatment station receives the uncooked protein pieces with inactivated tenderizer from the tenderizer applicator.

9. The system of claim 1, wherein the uncooked protein pieces are animal protein pieces.

10. The system of claim 9, wherein the animal protein pieces are selected from beef, pork, lamb, veal, and chicken.

11. The system of claim 1, wherein the selected enzyme tenderizer is selected from liquid or dry ficin, protease from aspergillus niger, protease from aspergillus orzae, actinidin, protease from bacillus subtilis, bromelain, and combinations of the foregoing.

12. The system of claim 11, wherein the selected enzyme tenderizer is a protease powder diluted in water to a range of between 0.0157 protease units to 0.0787 protease units per gram of protein.

13. The system of claim 1, wherein the sous vide cooker is programmed to sous vide cook the vacuum sealed pouches of uncooked protein pieces with inactive tenderizer at an initial temperature below an activation temperature of the selected enzyme tenderizer for an initial time interval prior to the first time interval; the initial time period selected from a gradual continuous rise in temperature from a temperature below the activation temperature of the selected enzyme tenderizer to the activation temperature of the selected enzyme tenderizer, multi-step rises in temperature from a temperature below the activation temperature of the selected enzyme tenderizer, through a series of selected time intervals within the initial time interval, and a continuous temperature below the activation temperature of the selected enzyme tenderizer for the entire initial time interval.

14. The system of claim 1, wherein the sous vide cooker is programmed to continue to sous vide cook the cooked tenderized protein pieces in the vacuum sealed pouches for a third time interval subsequent to the second time interval; the third time interval selected from cooking the cooked tenderized protein pieces in the vacuum sealed pouches at a temperature above the second temperature, and cooking the cooked tenderized protein pieces in the vacuum sealed pouches at a temperature below the second temperature.

15. The system of claim 1, wherein the sous vide cooker is programmed to sous vide cook the vacuum sealed pouches of uncooked protein pieces with inactive tenderizer at the first temperature for the first time interval to raise the temperature of the selected enzyme tenderizer to a peak activation temperature of the selected enzyme tenderizer.

16. A process for sous vide cooking and enzyme tenderization of pieces of protein, the process comprising:
applying a selected enzyme tenderizer to uncooked protein pieces at a temperature below the activation temperature of the selected enzyme tenderizer, resulting in uncooked protein pieces with inactive tenderizer;
vacuum sealing the uncooked protein pieces with inactive tenderizer in pouches, resulting in vacuum sealed pouches of uncooked protein pieces with inactive tenderizer;
sous vide cooking the vacuum sealed pouches of uncooked protein pieces with inactive tenderizer at a first temperature selected to activate the selected enzyme tenderizer for a first time interval that raises the temperature of the entire protein pieces to the first temperature to provide a selected degree of tenderization of the protein pieces, resulting in vacuum sealed pouches of tenderized protein pieces, then sous vide cooking the vacuum sealed pouches of tenderized protein pieces at second temperature higher than the first temperature selected to deactivate the selected enzyme tenderizer for a second time interval to cease tenderization of the protein pieces and completely cook the tenderized protein pieces, resulting in completely cooked tenderized protein pieces in the vacuum sealed pouches.

17. The process of claim 16, further comprising chilling the completely cooked tenderized protein pieces in the vacuum sealed pouches sufficiently to cease cooking the completely cooked tenderized protein pieces.

18. The process of claim 16, further comprising the initial step of selecting an enzyme tenderizer having a peak enzyme activation temperature within the cooking range of the protein pieces.

19. The process of claim 18, wherein selecting the enzyme tenderizer includes selecting an enzyme tenderizer having an enzyme deactivation temperature within the cooking range of the protein pieces.

20. The process of claim 16, wherein sous vide cooking the vacuum sealed pouches of uncooked protein pieces with inactive tenderizer includes sous vide cooking the vacuum sealed pouches of uncooked protein pieces with inactive tenderizer at an initial temperature below an activation temperature of the selected enzyme tenderizer for an initial time interval prior to the first time interval; the initial time period selected from a gradual continuous rise in temperature from a temperature below the activation temperature of the selected enzyme tenderizer to the activation temperature of the selected enzyme tenderizer, multi-step rises in temperature from a temperature below the activation temperature of the selected enzyme tenderizer, through a series of selected time intervals within the initial time interval, and a continuous temperature below the activation temperature of the selected enzyme tenderizer for the entire initial time interval.

21. The process of claim 16, wherein sous vide cooking the vacuum sealed pouches of uncooked protein pieces with inactive tenderizer includes continuing to sous vide cook the cooked tenderized protein pieces in the vacuum sealed pouches for a third time interval subsequent to the second time interval; the third time interval selected from cooking the cooked tenderized protein pieces in the vacuum sealed pouches at a temperature above the second temperature, and cooking the cooked tenderized protein pieces in the vacuum sealed pouches at a temperature below the second temperature.

22. The process of claim 16, wherein sous vide cooking the vacuum sealed pouches of uncooked protein pieces with inactive tenderizer includes sous vide cooking the vacuum sealed pouches of uncooked protein pieces with inactive tenderizer at the first temperature for the first time interval to raise the temperature of the selected enzyme tenderizer to a peak activation temperature of the selected enzyme tenderizer.

23. A process for sous vide cooking and enzyme tenderization of protein pieces, the process comprising:
matching an enzyme tenderizer to protein pieces to be tenderized and cooked, the enzyme tenderizer selected to have a peak enzyme activation temperature and an enzyme deactivation temperature within a cooking temperature of the protein pieces;
applying by a tenderizer applicator the enzyme tenderizer in an inactive state to the protein pieces in an uncooked state at a temperature below the activation temperature of the enzyme tenderizer, resulting in uncooked protein pieces with inactive tenderizer;
vacuum sealing the uncooked protein pieces with inactive tenderizer in pouches by a packaging machine, resulting in vacuum sealed pouches of uncooked protein pieces with inactive tenderizer; and
sous vide cooking the vacuum sealed pouches of uncooked protein pieces with inactive tenderizer by a sous vide cooker at the peak enzyme activation temperature for a first time interval to provide a selected degree of tenderization of the protein pieces, resulting in vacuum sealed pouches of tenderized protein pieces, then increasing the temperature in the sous vide cooker to continue to sous vide cook the vacuum sealed pouches of tenderized protein pieces at the enzyme deactivation temperature to deactivate the selected enzyme tenderizer for a second time interval to cease tenderization of the protein pieces, resulting in completely cooked tenderized protein pieces in the vacuum sealed pouches.

24. The process of claim 23, further comprising chilling by a chiller the cooked tenderized protein pieces in the vacuum sealed pouches sufficiently to cease cooking the completely cooked tenderized protein pieces.

25. The process of claim 23, wherein cooking the uncooked protein pieces at the peak enzyme activation temperature raises the temperature of the entire protein pieces to the peak enzyme activation temperature and partially cooks the protein pieces.

26. The process of claim 23, wherein the enzyme tenderizer is Protease of bacillus subtilis, the enzyme activation temperature is 135° F. (57.2° C.), the enzyme deactivation temperature is 155° F. (68.3° C.), and the protein pieces are beef.

27. The process of claim 23, wherein applying by a tenderizer applicator the enzyme tenderizer in an inactive state to the protein pieces in an uncooked state is selected from applying the enzyme tenderizer directly to the protein pieces, injecting the protein pieces with the enzyme tenderizer, depositing the enzyme tenderizer in the pouches prior to, simultaneously with, or subsequent to placing the protein pieces in the pouches, and combinations of the foregoing.

28. A system for sous vide cooking and enzyme tenderization, the system comprising:
a packaging machine that vacuum seals uncooked protein pieces with inactive tenderizer in pouches;
a tenderizer applicator that deposits a selected enzyme tenderizer into the pouches at a temperature below an activation temperature of the selected enzyme tenderizer, resulting in uncooked protein pieces with inactive tenderizer in the pouches;
a sous vide cooker that is programmed to sous vide cook the vacuum sealed pouches of uncooked protein pieces with inactive tenderizer at a first temperature for a first time interval selected to raise the temperature of the selected enzyme tenderizer to activate the selected enzyme tenderizer to provide a selected degree of tenderization of the protein pieces, resulting in vacuum sealed pouches of tenderized protein pieces, then continue sous vide cooking the vacuum sealed pouches of tenderized protein pieces at second temperature, higher than the first temperature, for a second time interval selected to deactivate the selected enzyme tenderizer to cease tenderization of the protein pieces, resulting in cooked tenderized protein pieces in the vacuum sealed pouches; and
a chiller that chills the cooked tenderized protein pieces in the vacuum sealed pouches sufficiently to cease cooking the cooked tenderized protein pieces.
